(19) United States
(12) Patent Application Publication
(10) Pub. No.: US 2021/0357239 A1
(43) Pub. Date: Nov. 18, 2021

(54) METHODS AND SYSTEMS FOR MANAGING COMPUTING VIRTUAL MACHINE INSTANCES

(71) Applicant: Capital One Services, LLC, McLean, VA (US)

(72) Inventor: Sherif MAKARY, Richmond Hill (CA)

(73) Assignee: Capital One Services, LLC, McLean, VA (US)

(21) Appl. No.: 15/931,645

(22) Filed: May 14, 2020

(51) Int. Cl. G06F 9/455

(52) U.S. Cl. CPC G06F 9/45558; G06F 2009/45562; G06F 2009/45595

(57) ABSTRACT

Disclosed are systems and methods for managing computing virtual machine instances. A method may include obtaining a state of a virtual machine instance operating in a first cloud environment at a point in time; obtaining metadata associated with the virtual machine instance at the point in time; obtaining metadata associated with the first cloud environment in which the virtual machine instance is operating at the point in time; storing the obtained state of the virtual machine instance at the point in time, the obtained metadata associated with the virtual machine instance at the point in time, and the obtained metadata associated with the first cloud environment in which the virtual machine instance is operating at the point in time; terminating the virtual machine instance operating in the first cloud environment; and restoring, via the one or more processors, the terminated virtual machine instance in the first cloud environment or a second cloud environment at a later point in time.

### TECHNICAL FIELD

Various embodiments of the present disclosure relate generally to methods and systems for managing computing virtual machine instances.

### BACKGROUND

Cloud computing may be used to develop, load, and/or test web-based applications. By way of example, a cloud may provide a web service that allows users to utilize computers on which to run their own computer applications, thereby allowing scalable deployment of applications through which a use can create a virtual machine (also referred to as a “virtual machine instance”) containing any desired software. Management of such virtual machine instances may provide numerous challenges including terminating and re-instituting virtual machine instances to reserve/exploit available resources. Accordingly, there exists a need for an improved method of managing such virtual machine instances.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for managing computing virtual machine instances.

In one aspect, there is provided a method including: obtaining, via one or more processors, a state of a virtual machine instance operating in a first cloud environment at a point in time, wherein the virtual machine instance comprises one or more virtual servers in the first cloud environment; obtaining, via the one or more processors, metadata associated with the virtual machine instance at the point in time; obtaining, via the one or more processors, metadata associated with the first cloud environment in which the virtual machine instance is operating at the point in time; storing, via the one or more processors, the obtained state of the virtual machine instance at the point in time, the obtained metadata associated with the virtual machine instance at the point in time, and the obtained metadata associated with the first cloud environment in which the virtual machine instance is operating at the point in time; terminating, via the one or more processors, the virtual machine instance operating in the first cloud environment; and restoring, via the one or more processors, the terminated virtual machine instance in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time.

In another aspect, there is provided a non-transitory computer-readable medium containing instructions that, when executed by a processor, cause the processor to perform a method including: obtaining a state of a virtual machine instance operating in a first cloud environment at a point in time, wherein the virtual machine instance comprises one or more virtual servers in the first cloud environment; obtaining metadata associated with the virtual machine instance at the point in time; obtaining metadata associated with the first cloud environment in which the virtual machine instance is operating at the point in time; storing the obtained state of the virtual machine instance at the point in time, the obtained metadata associated with the virtual machine instance at the point in time, and the obtained metadata associated with the first cloud environment in which the virtual machine instance is operating at the point in time; terminating the virtual machine instance operating in the first cloud environment; and restoring the terminated virtual machine instance in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time.

In another aspect, there is provided a method including: obtaining, via one or more processors, a state of a virtual machine instance operating in a first cloud environment at a point in time, wherein the virtual machine instance comprises one or more virtual servers in the first cloud environment, and wherein the virtual machine instance is configured to provide a relational database service (RDS) or a cloud computing platform; obtaining, via the one or more processors, metadata associated with the virtual machine instance at the point in time; obtaining, via the one or more processors, metadata associated with the first cloud environment in which the virtual machine instance is operating at the point in time; storing, via the one or more processors, the obtained state of the virtual machine instance at the point in time, the obtained metadata associated with the virtual machine instance at the point in time, and the obtained metadata associated with the first cloud environment in which the virtual machine instance is operating at the point in time; providing access, via the one or more processors, to one or more of the stored virtual machine instance at the point in time, the stored metadata associated with the virtual machine instance at the point in time, and/or the stored metadata associated with the first cloud environment at the point in time via a web interface; terminating, via the one or more processors, the virtual machine instance operating in the first cloud environment; and restoring, via the one or more processors, the terminated virtual machine instance in the first cloud environment or a second cloud environment at a later point in time based on at least one or more of the stored state of the virtual machine instance at the point in time, the stored metadata associated with the virtual machine instance at the point in time, or the stored metadata associated with the first cloud environment at the point in time.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system for managing computing virtual machine instances, according to one or more embodiments.

FIG. 2 depicts an exemplary embodiment of managing computing virtual machine instances utilizing the exemplary system depicted in FIG. 1.

FIG. 3 depicts a flowchart of an exemplary method of managing computing virtual machine instances, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

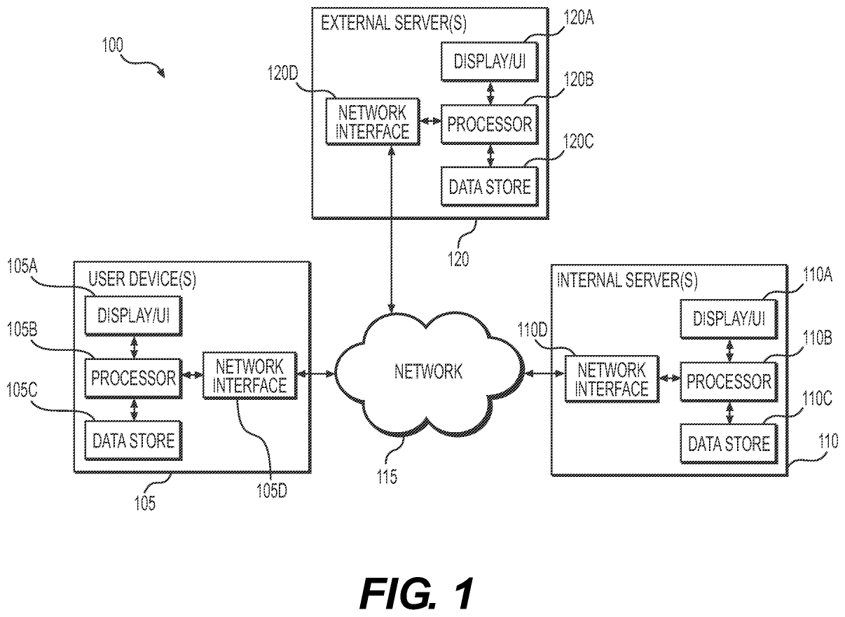

FIG. 1 depicts an exemplary system 100 for managing computing virtual machine instances, according to one or more embodiments. The system 100 may include one or more user device(s) 105, an internal server 110 configured to provide an internal service to the one or more user device(s) 105, a network 115, and/or an external server 120 configured to provide an external service to the one or more user device(s) 105. Hereafter, while the internal server 110 and/or the external server 120 may interact with one or a plurality of the one or more user devices 105, this description will refer to the one or more user devices 105 as “the user device 105,” so as to simplify the description of the concepts described herein. One of skill in the art would recognize that the internal server 110 and/or the external server 120 may configure the one or more user devices 105 so as to experience different functionalities and/or have access to different information (e.g., determined by credentials such as user ID/password). Additionally, while the functionality carried out by the internal server 110, the external server 120, and/or the user device 105 are discussed herein separately, in practice these features may be executed on more or fewer devices.

The user device 105, the internal server 110, and/or the external server 120 may be connected via the network 115, using one or more standard communication protocols. The network 115 may be one or a combination of a wide area network (e.g., the Internet), a local network, or other network. The user device 105, the internal server 110, and/or the external server 120 may transmit and receive messages from each other across the network 115.

The user device 105 may include a display/user interface (UI) 105A, a processor 1058, a data store 105C, and/or a network interface 105D. The user device 105 may be a computer, a cell phone, a tablet, etc. The user device 105 may execute, by the processor 105B, an operating system (O/S) and at least one application (each stored in data store 105C). The application may be a browser program or a mobile application program (which may also be a browser program in a mobile O/S). The application may generate one or more graphic user interfaces (GUIs) based on instructions/information stored in the data store 105C, instructions/information received from the internal server 110, and/or instructions/information received from the external server 120. For instance, the GUIs might be application GUIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the internal network 110. The processor 105B, while executing the application, may receive user inputs from the display/UI 105A, and perform actions or functions in accordance with the application.

The internal server(s) 110 may include a display/UI 110A, a processor 110B, a data store 110C, and/or a network interface 110D. The internal server 110 may be a computer, system of computers (e.g., rack server(s)), and/or or a cloud service computer system. The internal server 110 may execute, by the processor 110B, an operating system (O/S) and at least one instance of a server program (each stored in data store 110C). The internal server 110 may store or have access to server information (e.g., hosted on a third-party server). The display/UI 110A may be a touch screen or a display with other input systems (e.g., mouse, keyboard, etc.) for an operator of the internal server 110 to control the functions of the internal server 110 (e.g., update the server program and/or the server information). The network interface 110D may be a TCP/IP network interface for, e.g., Ethernet or wireless communications with the network 115.

The server program, executed by the processor 110B on the internal server 110, may be configured to perform a method for managing computing virtual machine instances. The method may include: obtaining a state of a virtual machine instance operating in a first cloud environment, e.g., an external service provided by the external server 120, at a point in time, wherein the virtual machine instance comprises one or more virtual servers in the first cloud environment; obtaining metadata associated with the virtual machine instance at the point in time; obtaining metadata associated with the first cloud environment in which the virtual machine instance is operating at the point in time; storing the obtained state of the virtual machine instance at the point in time, the obtained metadata associated with the virtual machine instance at the point in time, and the obtained metadata associated with the first cloud environment in which the virtual machine instance is operating at the point in time; terminating the virtual machine instance operating in the first cloud environment; and restoring the virtual machine instance in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time. Further details of the server program are discussed below.

The external server(s) 120 may include a display/UI 120A, a processor 120B, a data store 120C, and/or a network interface 120D. In some embodiments, the external server 120 may be a virtual computing platform. The external server 120 may be a computer, system of computers (e.g., rack server(s)), and/or or a cloud service computer system. In the context of the current disclosure, the term “cloud” may be broadly referred to as a collection of computing instances, storage, and/or network devices that work together in concert. By way of example, a cloud may provide a web service that allows users to utilize computers on which to run their own computer applications, thereby allowing scalable deployment of applications through which a user can create a virtual machine (also referred to as a “virtual machine instance”) containing any desired software. In the context of the current disclosure, a virtual machine instance may be referred to as a collection of resources and resource states of a virtual machine, e.g., a virtual computer system. A virtual machine may comprise a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. For example, virtual machines may be configured to run on a collection of physical hosts. In such instances, each virtual machine may use compute resources (e.g., CPU and memory), network resources (e.g., network interfaces), and storage resources (e.g., local disks, NAS or SAN connections) of the underlying physical host system. In some embodiments, the user may create, launch, and/or terminate virtual machine instances as needed. The external server 120 may execute, by the processor 120B, an operating system (O/S) and at least one instance of a server program (each stored in data store 120C). The external server 120 may store or have access to server information (e.g., hosted on a third-party server). The display/UI 120A may be a touch screen or a display with other input systems (e.g., mouse, keyboard, etc.) for an operator of the external server 120 to control the functions of the external server 120 (e.g., update the server program and/or the server information). The network interface 120D may be a TCP/IP network interface for, e.g., Ethernet or wireless communications with the network 115.

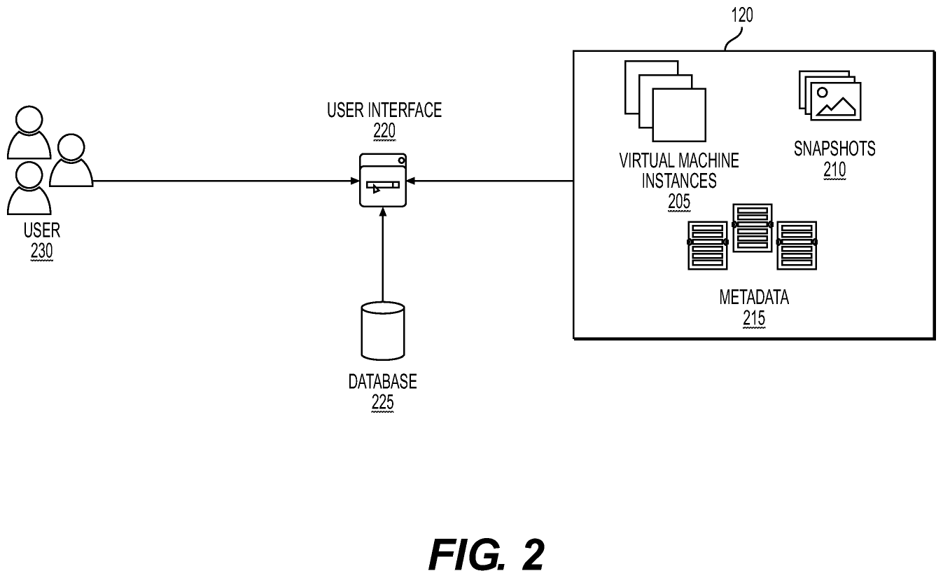

FIG. 2 depicts an exemplary embodiment of managing computing virtual machine instances utilizing system 100 of FIG. 1. As shown in FIG. 2, one or more users 230 may utilize external services, e.g., cloud computing, provided by the external server 120 via user device 105 and/or internal server 110, as will be described in further detail below.

The one or more users 230 may be working on a project to, for example, develop, load, and/or test web-based applications on the cloud provided by the external server 120. The project may utilize one or more virtual machine instances on the cloud. That is, the one or more users 230 may create, launch, and/or terminate virtual machine instances on the cloud. While there may be one or more virtual machine instances, this description will refer to the one or more virtual machine instances as “the virtual machine instance,” so as to simplify the description of the concepts described here. In some embodiments, a user 230 may want to suspend an active project for a period of time. In such embodiments, the virtual machine instance associated with the project may also need to be suspended to avoid expenses associated with keeping the virtual machine instance running on the cloud and/or free up additional resources for utilization elsewhere. As such, there is a need to manage the virtual machine instance in such scenarios, as described in further detail below.

The user 230 may initiate a recordation of state (e.g., “snapshot”) of the virtual machine instance running on the cloud. In some embodiments, the user 230 may initiate the snapshot of the virtual machine instance via a user interface 220 on the user device 105 (e.g., via display/UI 105A) and/or the internal server 110 (e.g., via display/UI 110A). In some embodiments, the user device 105 and/or the internal server 110 may periodically initiate and store the snapshot and associated metadata as described in further detail below.

In some embodiments, metadata associated with the virtual machine instance and metadata associated with the cloud environment in which the virtual machine instance is running may be obtained in addition to the snapshot of the virtual machine instance at a certain point in time. Metadata associated with the virtual machine instance may include configurations of the virtual machine instance. In some embodiments, the virtual machine instance may be a relational database service (RDS). In such embodiments, the metadata associated with the virtual machine instance may include, but is not restricted to, the following: virtual machine instance identifier, engine version, database name, license model, option group(s), parameter group, deletion protection, virtual machine instance class, multiple storage copies, encryption, key management solution (KMS) key, storage type, IOPS, storage, performance insights enabled, availability zone, virtual private cloud (VPC), subnet group/subnets, VPC security groups, public accessibility, port, maintenance window, auto minor version upgrade, tags, etc. In some embodiments, virtual machine instance identifier may be a unique identifier for a virtual machine instance, e.g., a cloud infrastructure component, in a cloud environment, e.g., a cloud account. In some embodiments, engine version may refer to a version of the virtual machine instance being run in the cloud environment. As a non-limiting example, engine version may be a product version being run in the cloud environment such as Postgres v10.5.2. In some embodiments, database name may be a name assigned to a database. In such embodiments, database name may be used while initiating connection to a database server. In some embodiments, license model may indicate a license type for a specific database. The database may be Open Source and/or Bring Your Own License (BYOL). In some embodiments, option group may indicate a selection of optional components that may be installed within a virtual machine instance, e.g., a database virtual machine instance. In some embodiments, parameter group may include a list of environment options that may exist within the virtual machine instance, e.g., a database virtual machine instance. In some embodiments, deletion protection may comprise a flag that may indicate that protection may be provided for the virtual machine instance, e.g., database virtual machine instance, against accidental deletion. In some embodiments, virtual machine instance class may indicate processing power, capabilities and/or memory required for the virtual machine instance. In some embodiments, multiple storage may indicate that similar virtual machine instances may be created and/or stored in separate data centers for disaster recovery. In some embodiments, encryption may indicate whether data associated with the virtual machine instance should be encrypted prior to being stored, e.g., written to a disk. In some embodiments, KMS key may indicate what type of encryption algorithm may be used. In some embodiments, storage type may indicate what type of storage media, e.g., solid state drive (SSD) or magnetic, may be used to store data. In some embodiments, input/output operations per second (IOPS) may refer an input/output performance measurement used to characterize storage devices. In some embodiments, storage may refer to an amount of storage provided by the storage type. In some embodiments, performance insights enabled may indicate that an associated service may provide more detailed monitoring for a cloud virtual machine instance. In some embodiments, availability zone may indicate a physical location for a datacenter with in a cloud region associated with the cloud environment. For example, the U.S. East region may have three separate data centers physically separated which may be referred to as availability zones (AZ). Accordingly, the availability zone may indicate which data center is associated with the cloud environment. In some embodiments, VPC may refer to separate customer infrastructures that are logically separated within the cloud. In some embodiments, subnet groups/subnets may comprise smaller networks that may represent customer virtual cloud for relatively more granular management. In some embodiments, VPC security groups may comprise firewall rules used by the customer, e.g., a user 230 via user device 105 and/or internal server 110, restrict access to associated virtual machine instances. In some embodiments, public accessibility may indicate whether the virtual machine instance may be accessible directly through the internet. In some embodiments, port may indicate a number that specifies an access point to a service. In some embodiments, maintenance window may indicate a period of time during which any maintenance operation, if necessary, be performed for the virtual machine instance. In some embodiments, auto minor version upgrade may indicate whether the cloud provider may apply minor patches and updates automatically on the virtual machine instance. In some embodiments, tags may refer to labels assigned to virtual machine instances. Tag may enable better tracking, cost analysis and governance within the cloud environment.

The metadata associated with the cloud environment may include, but is not restricted to, the following: parameter group details, security group details, subnet details, virtual private cloud (VPC) details, etc. In some embodiments, parameter group details may include parameters can be used in the cloud environment, e.g., database environment. The parameters may be preconfigured with default values and/or manually input. In some embodiments, security group details may define inbound and outbound rules that restrict traffic going into and coming out of the virtual machine instance. The metadata associated with the cloud environment may include one or more of such security group details. In some embodiments, the security group details may be associated with other virtual machine instances within the cloud environment. In some embodiments, subnet details may include a range of IP addresses allowed by the subnet. For example, the range of IP address may be allocated based on a method, e.g., Classless Inter-Domain Routing (CIDR), for allocating IP addresses and IP routing. In some embodiments, subnet details may further include an access control list (ACL) including a list of permissions attached to the subnet. For example, the ACL may include a set of rules for controlling traffic going in and coming out of one or more subnets. In some embodiments, VPC details may include at least one or more of the following: available subnets in the cloud environment, IP address ranges allowed by each of the available subnets, or ACL rules for traffic monitoring and/or logging configurations for the cloud environment.

In some embodiments, the virtual machine instance may be a cloud computing platform, e.g., a virtual machine. In such embodiments, the metadata associated with the virtual machine instance may include, but is not restricted to, the following: virtual machine instance identifier, virtual machine instance type, reserved IP (also referred to as elastic IP), availability zone, VPC, VPC security groups, tags, machine image (MI), identity and access management (IAM) role, termination protection, virtual machine instance type (also referred to as virtual machine instance class), auto-assign public IP, placement group, detailed monitoring, elastic inference, etc. In some embodiments, MI may comprise an operating system image used to build the virtual machine instance, for example, Window 10 Pro or Red hat Linux. In some embodiments, IAM role may indicate a group of permission allowed to be performed by the virtual machine instance. For example, the IAM role may indicate whether the virtual machine instance may communicate with another service, access information associated with another virtual machine instance, etc. In some embodiments, placement group may indicate whether there has been a request to group multiple virtual machine instances as physically close to each other as possible within the cloud environment. In some embodiments, reserved IP may be a specific IP address reserved for a specific user that may be reused whenever the user terminate and recreates a virtual machine instance within the cloud environment. In some embodiments, virtual machine instance type may indicate the strength of the virtual machine instance processing power. In some embodiments, the metadata may further include virtual machine instance type unlimited which may indicate that a period of performance spikes may be permitted regardless of the requested virtual machine instance type. In some embodiments, the metadata associated with the cloud environment may include, but is not restricted to, the following: security group details, subnets details, VPC Details, IAM role details, etc.

The snapshot of the virtual machine instance, the metadata associated with the virtual machine instance, and the metadata associated with the cloud environment in which the virtual machine instance is running at the certain point in time may be stored in any combination in a database 225 and/or the data store 120C of the external server 120. In some embodiments, the database 225 may be included in the data store 105C, 110C of the user device 105 and/or the internal server 110. In some embodiments, the snapshot of the virtual machine instance may be stored with one or more tags associated with the virtual machine instance in the database 225 and/or the data store 120C of the external server 120. The one or more tags may include a concise description of the virtual machine instance, e.g., one or more key words associated with the virtual machine instance. In some embodiments, the stored snapshot of the virtual machine instance, metadata associated with the virtual machine instance, and metadata associated with the cloud environment in which the virtual machine instance is running at the certain point in time may be accessed by the user 230 via the user interface 220.

The virtual machine instance may be terminated once the complete snapshot of the virtual machine instance has been stored. In some embodiments, the user 230 may want to restore the terminated virtual machine instance on the cloud, e.g., provided by the external server 120 and/or any other external server, at a later point in time. In such embodiments, the user 230 may access the stored complete snapshot of the virtual machine instance via the user interface 220 and initiate the restoring process of the virtual machine instance in the cloud based on the stored complete snapshot, e.g., the stored configurations such as the metadata associated with virtual machine instance and the metadata associated with the cloud environment in which the virtual machine instance was running at the prior point in time. Accordingly, the virtual machine instance may be restored on the cloud substantially the same as before. In some embodiments, the user 230 may be able to restore the terminated virtual machine instance on the cloud at the later point in time with one click of a button by the user 230 via the user interface 220. In some embodiments, the user 230 may be able to obtain information regarding the virtual machine instance based on the stored complete snapshot via the user interface 220. For example, the user 230 may be able to utilize the user interface 220 to observe how the virtual machine instance had been previously created based on the stored complete snapshot. It is understood that the user 230 may be able to access complete snapshots of more than two virtual machine instances using the user interface 220. That is, the user 230 may be able to understand how the virtual machine instance associated with each stored complete snapshot had been previously created and restore the virtual machine instances at a later point in time.

Some conventional cloud platforms may not allow a virtual machine instance to be suspended for more than a predetermined period of time, for example, seven days. As such, the embodiments disclosed herein allow the virtual machine instance to be terminated and restored at any subsequent time, e.g., after any predetermined period of time set by conventional cloud platforms. The terminated virtual machine instance may be managed on a user interface, as described herein, and the terminated virtual machine instance may be restored at any subsequent time by the user with one simple click of a button on the user interface. Accordingly, manual and complicated efforts to recreate terminated virtual machine instances at a later point in time may be reduced. Additionally, by terminating the virtual machine instance, costs associated with running the virtual machine instance and/or keeping the virtual machine instance suspended in the cloud may be saved. Some conventional cloud platforms may place certain requirements in order to suspend a virtual machine instance. For example, conventional cloud platforms may require for a database virtual machine instance not to have a read replica or have data replicated to another standby virtual machine instance for disaster recovery in order to suspend a virtual machine instance. Some conventional cloud platforms may use automated pipelines for cloud deployment, which may simplify some configurations for virtual machine instances, but does not facilitate data management of the virtual machine instances. Additionally, such pipelines may be restricted to a specific cloud environment. The embodiments disclosed herein are directed to overcoming one or more of these above-referenced shortcomings of conventional cloud platforms.

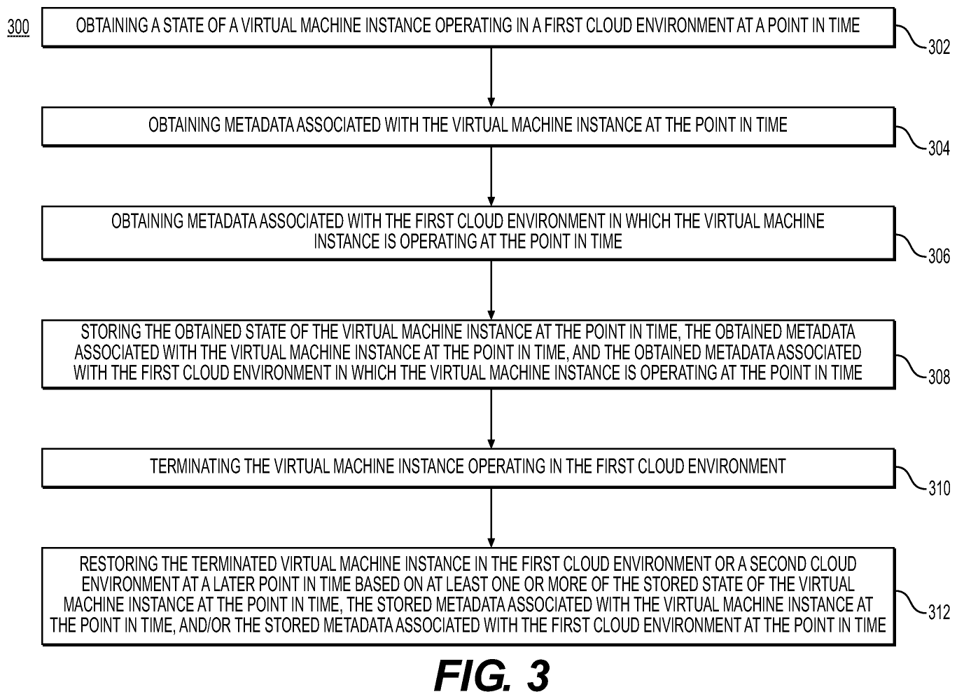

FIG. 3 depicts a flowchart of an exemplary process 300 according to one or more embodiments, and may be performed in the exemplary environment of FIG. 1. Process 300 may, in some embodiments, begin with step 302, in which a state (e.g., a snapshot) of a virtual machine instance operating in a first cloud environment at a point in time may be obtained. In some embodiments, the virtual machine instance may include one or more virtual servers in the first cloud environment.

In step 304, metadata associated with the virtual machine instance at the point in time may be obtained. In some embodiments, the virtual machine instance may be configured to provide a relational database service (RDS). In such embodiments, the obtained state of metadata associated with the virtual machine instance at the point in time may include information regarding one or more of: an identifier identifying the virtual machine instance, an engine version, a database name, a license model, option groups, a parameter group, deletion protection, virtual machine instance class, one or more availability zones, encryption, key management service, input/output operations per second (IOPS), virtual private cloud (VPC), subnet group and/or subnets, VPC security groups, public accessibility, one or more ports, maintenance window, and/or one or more labels indicating the RDS.

In some embodiments, the virtual machine instance may be configured to provide a cloud computing platform. In such embodiments, the obtained metadata associated with the virtual machine instance at the point in time may include information regarding one or more of: an identifier identifying the virtual machine instance, a virtual machine instance type, an elastic internet protocol (IP) address, an availability zone, VPC security zones, one or more labels indicating the cloud computing platform, a machine image of the cloud computing platform, identity and access management (IAM) role, termination protection, automatically assigned public IP address, placement group, and/or elastic inference.

In step 306, metadata associated with the first cloud environment in which the virtual machine instance is operating at the point in time may be obtained. In some embodiments, the obtained metadata associated with the first cloud environment in which the virtual machine instance is operating at the point in time may include information regarding one or more of: one or more security groups, one or more subnets, VPC, or IAM role.

In step 308, the obtained state of the virtual machine instance at the point in time, the obtained metadata associated with the virtual machine instance at the point in time, and/or the obtained metadata associated with the first cloud environment in which the virtual machine instance is operating at the point in time may be stored. In some embodiments, the step of storing may include storing two or more of (e.g., all of) the obtained state of the virtual machine instance at the point in time, the obtained metadata associated with the virtual machine instance at the point in time, and/or the obtained metadata associated with the first cloud environment together at a predetermined location (e.g., in a same database). In some embodiments, the step of storing may include storing one or more of the obtained state of the virtual machine instance at the point in time, the obtained metadata associated with the virtual machine instance at the point in time, and/or the obtained metadata associated with the first cloud environment for a predetermined period of time. In some embodiments, the predetermined period of time may exceed a period of seven days.

In step 310, the virtual machine instance operating in the first cloud environment may be terminated. In step 312, the terminated virtual machine instance may be restored in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time.

In some embodiments, process 300 may include a further step in which access to one or more of the stored state of the virtual machine instance at the point in time, the stored metadata associated with the virtual machine instance at the point in time, and/or the stored metadata associated with the first cloud environment at the point in time may be provided via a web interface. In some embodiments, process 300 may include a further step in which the virtual machine instance may be migrated to the second cloud environment based on one or more of the stored states.

In general, any process discussed in this disclosure that is understood to be computer-implementable, such as the process illustrated in FIG. 3 may be performed by one or more processors of a computer system, such as user device 105, one or more computers associated with internal server 110, and/or one or more computers associated with external server 120, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as user device 105, one or more computers associated with internal server 110, and/or one or more computers associated with external server 120, may include one or more computing devices. If the one or more processors are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

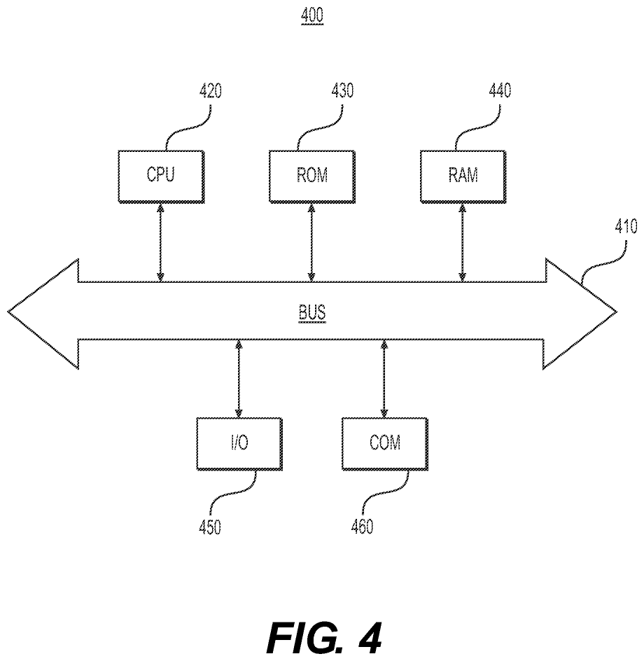

FIG. 4 illustrates an example of a computing device 400 of a computer system, such as user device 105, one or more computers associated with internal server 110, and/or one or more computers associated with external server 120. As shown in FIG. 4, device 400 (e.g., user device 105, internal server 110, and/or external server 120) may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order (e.g., steps may be added, removed, or repeated), or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It is intended that the specification and examples be considered as exemplary only, with a true scope and spirit of the disclosure being indicated by the following claims.

What is claimed is:

1. A computer-implemented method comprising:
obtaining, via one or more processors, a state of a virtual machine instance operating in a first cloud environment at a point in time, wherein the virtual machine instance comprises one or more virtual servers in the first cloud environment;
obtaining, via the one or more processors, metadata associated with the virtual machine instance at the point in time;
obtaining, via the one or more processors, metadata associated with the first cloud environment in which the virtual machine instance is operating at the point in time;
storing, via the one or more processors, the obtained state of the virtual machine instance at the point in time, the obtained metadata associated with the virtual machine instance at the point in time, and the obtained metadata associated with the first cloud environment in which the virtual machine instance is operating at the point in time;
terminating, via the one or more processors, the virtual machine instance operating in the first cloud environment; and
restoring, via the one or more processors, the terminated virtual machine instance in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time.

2. The computer-implemented method of claim 1, wherein the virtual machine instance is configured to provide a relational database service (RDS).

3. The computer-implemented method of claim 2, wherein the obtained metadata associated with the virtual machine instance at the point in time includes information regarding one or more of: an identifier identifying the virtual machine instance, an engine version, a database name, a license model, option groups, a parameter group, deletion protection, virtual machine instance class, one or more availability zones, encryption, key management service, input/output operations per second (IOPS), virtual private cloud (VPC), subnet group and/or subnets, VPC security groups, public accessibility, one or more ports, maintenance window, and/or one or more labels indicating the RDS.

4. The computer-implemented method of claim 1, wherein the virtual machine instance is configured to provide a cloud computing platform.

5. The computer-implemented method of claim 4, wherein the obtained metadata associated with the virtual machine instance at the point in time includes information regarding one or more of: an identifier identifying the virtual machine instance, a virtual machine instance type, an elastic internet protocol (IP) address, an availability zone, VPC security zones, one or more labels indicating the cloud computing platform, a machine image of the cloud computing platform, identity and access management (IAM) role, termination protection, automatically assigned public IP address, placement group, and/or elastic inference.

6. The computer implemented method of claim 1, wherein the obtained metadata associated with the first cloud environment in which the virtual machine instance is operating at the point in time includes information regarding one or more of: one or more security groups, one or more subnets, VPC, and/or IAM role.

7. The computer-implemented method of claim 1, wherein storing the obtained state of the virtual machine instance at the point in time, the obtained metadata associated with the virtual machine instance at the point in time, and the obtained metadata associated with the first cloud environment in which the virtual machine instance is operating at the point in time comprises:
storing two or more of the obtained state of the virtual machine instance, the obtained metadata associated with the virtual machine instance, and/or the obtained metadata associated with the first cloud environment together at a predetermined location.

8. The computer-implemented method of claim 1, wherein storing the obtained state of the virtual machine instance at the point in time, the obtained metadata associated with the virtual machine instance at the point in time, and the obtained metadata associated with the first cloud environment in which the virtual machine instance is operating at the point in time comprises:
storing one or more of the obtained state of the virtual machine instance, the obtained metadata associated with the virtual machine instance, and/or the obtained metadata associated with the first cloud environment for a predetermined period of time, wherein the predetermined period of time exceeds a period of seven days.

9. The computer-implemented method of claim 1, further comprising:
providing access, via a web interface, to one or more of the stored virtual machine instance at the point in time, the stored metadata associated with the virtual machine instance at the point in time, and/or the stored metadata associated with the first cloud environment at the point in time.

10. The computer-implemented method of claim 1, further comprising:
migrating the virtual machine instance to the second cloud environment based on one or more of the stored virtual machine instance at the point in time, the stored metadata associated with the virtual machine instance at the point in time, and/or the stored metadata associated with the first cloud environment at the point in time.

11. A non-transitory computer-readable medium containing instructions that, when executed by a processor, cause the processor to perform a method comprising:
obtaining a state of a virtual machine instance operating in a first cloud environment at a point in time, wherein the virtual machine instance comprises one or more virtual servers in the first cloud environment;
obtaining metadata associated with the virtual machine instance at the point in time;
obtaining metadata associated with the first cloud environment in which the virtual machine instance is operating at the point in time;
storing the obtained state of the virtual machine instance at the point in time, the obtained metadata associated with the virtual machine instance at the point in time, and the obtained metadata associated with the first cloud environment in which the virtual machine instance is operating at the point in time;
terminating the virtual machine instance operating in the first cloud environment; and
restoring the terminated virtual machine instance in the first cloud environment or a second cloud environment at a later point in time based on at least one or more of the stored state of the virtual machine instance at the point in time, the stored metadata associated with the virtual machine instance at the point in time, and/or the stored metadata associated with the first cloud environment at the point in time.

12. The non-transitory computer-readable medium of claim 11, wherein the virtual machine instance is configured to provide a relational database service (RDS).

13. The non-transitory computer-readable medium of claim 12, wherein the obtained metadata associated with the virtual machine instance at the point in time includes information regarding one or more of: an identifier identifying the virtual machine instance, an engine version, a database name, a license model, option groups, a parameter group, deletion protection, virtual machine instance class, one or more availability zones, encryption, key management service, input/output operations per second (IOPS), virtual private cloud (VPC), subnet group and/or subnets, VPC security groups, public accessibility, one or more ports, maintenance window, or one or more labels indicating the RDS.

14. The non-transitory computer-readable medium of claim 11, wherein the virtual machine instance is configured to provide a cloud computing platform.

15. The non-transitory computer-readable medium of claim 14, wherein the obtained metadata associated with the virtual machine instance at the point in time includes information regarding one or more of: an identifier identifying the virtual machine instance, a virtual machine instance type, an elastic internet protocol (IP) address, an availability zone, VPC security zones, one or more labels indicating the cloud computing platform, a machine image of the cloud computing platform, identity and access management (IAM) role, termination protection, automatically assigned public IP address, placement group, or elastic inference.

16. The non-transitory computer-readable medium of claim 11, wherein the obtained metadata associated with the first cloud environment in which the virtual machine instance is operating at the point in time includes information regarding one or more of: one or more security groups, one or more subnets, VPC, or IAM role.

17. The non-transitory computer-readable medium of claim 11, wherein storing the obtained state of the virtual machine instance at the point in time, the obtained metadata associated with the virtual machine instance at the point in time, and the obtained metadata associated with the first cloud environment in which the virtual machine instance is operating at the point in time comprises:
storing two or more of the obtained state of the virtual machine instance, the obtained metadata associated with the virtual machine instance, and/or the obtained metadata associated with the first cloud environment together at a predetermined location.

18. The non-transitory computer-readable medium of claim 11, wherein storing the obtained state of the virtual machine instance at the point in time, the obtained metadata associated with the virtual machine instance at the point in time, and the obtained metadata associated with the first cloud environment in which the virtual machine instance is operating at the point in time comprises:
storing one or more of the obtained state of the virtual machine instance, the obtained metadata associated with the virtual machine instance, and/or the obtained metadata associated with the first cloud environment for a predetermined period of time, wherein the predetermined period of time exceeds a period of seven days.

19. The non-transitory computer-readable medium of claim 11, the method further comprising:
providing access, via a web interface, to one or more of the stored virtual machine instance at the point in time, the stored metadata associated with the virtual machine instance at the point in time, and/or the stored metadata associated with the first cloud environment at the point in time.

20. A computer-implemented method comprising:
obtaining, via one or more processors, a state of a virtual machine instance operating in a first cloud environment at a point in time, wherein the virtual machine instance comprises one or more virtual servers in the first cloud environment, and wherein the virtual machine instance is configured to provide a relational database service (RDS) or a cloud computing platform;
obtaining, via the one or more processors, metadata associated with the virtual machine instance at the point in time;
obtaining, via the one or more processors, metadata associated with the first cloud environment in which the virtual machine instance is operating at the point in time;
storing, via the one or more processors, the obtained state of the virtual machine instance at the point in time, the obtained metadata associated with the virtual machine instance at the point in time, and the obtained metadata associated with the first cloud environment in which the virtual machine instance is operating at the point in time;
providing access, via the one or more processors, to one or more of the stored virtual machine instance at the point in time, the stored metadata associated with the virtual machine instance at the point in time, and/or the stored metadata associated with the first cloud environment at the point in time via a web interface;
terminating, via the one or more processors, the virtual machine instance operating in the first cloud environment; and
restoring, via the one or more processors, the terminated virtual machine instance in the first cloud environment or a second cloud environment at a later point in time based on at least one or more of the stored state of the virtual machine instance at the point in time, the stored metadata associated with the virtual machine instance at the point in time, or the stored metadata associated with the first cloud environment at the point in time.
